(19) United States
(12) Patent Application Publication
(10) Pub. No.: US 2005/0043443 A1
(43) Pub. Date: Feb. 24, 2005

(54) Molding compositions and their use

(76) Inventors: Robert Hubertus Van Mullekom, Venlo (NL); Detlev Joachimi, Krefeld (DE); Alexander Karbach, Krefeld (DE); Peter Persigehl, Ratingen (DE); Maarten De Bock, Kalmthout (BE)

Correspondence Address: LANXESS CORPORATION;PATENT DEPARTMENT/ BLDG 14, 100 BAYER ROAD, PITTSBURGH, PA, 15205-9741, US

(21) Appl. No.: 10/919,044

(22) Filed: Aug. 16, 2004

(30) Foreign Application Priority Data
Aug. 18, 2003 (DE) 10337886.3

(51) Int. Cl. C08K 9/00; C08K 3/40

(52) U.S. Cl. 523/216; 524/494

(57) ABSTRACT

A thermoplastic glass fibers reinforced molding composition that exhibits improved mechanical properties and resistance to hydrolysis is disclosed. The composition contains at least one thermoplastic polymer, sized glass fibers, and optional conventional additives and auxiliary substances. The sizing agent that is substantially free of emulsifiers not bound to the resin contains (a) at least one epoxide-functional, oligomeric resin, having epoxide group content of 0.15 to 0.75 mole per 100 g of resin, average functionality of at least 2.3 epoxide groups per molecule, (b) at least one epoxide curing agents, and (c) at least one silane coupling agent.

### BACKGROUND OF THE INVENTION

1. Field of the Invention

The invention relates to glass reinforced thermoplastic molding compositions and more particularly to compositions containing sized glass fibers.

2. Description of Background Art

The properties of composites of glass fibers and polymers are influenced to a large extent by the shear strength between glass fibers and the polymer matrix surrounding the glass fibers. The purpose of the sizing agent is to form this composite between the glass fibers and the matrix polymer and at the same time to ensure the producibility and processability of the glass fibers. Compositions of water, a polymeric binder (the so-called film-forming agent), a coupling agent, lubricants, antistatics and further auxiliary substances are used as sizing agents. In general organic, water-dispersible or water-soluble polyvinyl acetate, polyester, polyester epoxide, polyurethane, polyacrylate or polyolefin resins or their mixtures are used as binder.

In general film-forming agents and coupling agents are chosen so that there is an affinity between the polymer matrix and the film-forming agent and so that a mechanical composite is formed between glass fibers and polymer matrix. It is understood therefore that the formulations of the sizing agents have to be optimized to the respective polymer matrix and that the properties of the composites react sensitively to changes in the sizing agent composition.

EP-A 612 798 describes glass fiber-reinforced molding compositions in which the glass fibers comprise a sizing agent that contains, apart from conventional sizing materials, also an epoxide-functional, oligomeric resin that
i) has a content of epoxide groups of 0.15 to 0.75 mole per 100 g of epoxide-functional, oligomeric resin and
ii) has on average a functionality of at least 2.3 epoxide groups per molecule, and also
iii) is substantially free of emulsifiers not bound to the resin.

The molding compositions known from EP-A 612 798 have outstanding mechanical properties and a good temperature stability and are hydrolytically and solvolytically very resistant.

The Applicants of the present invention realized that the disadvantage, however, is that in molding compositions with glass fibers whose glass fiber sizing agents contain for example the epoxide-functional, oligomeric resins mentioned above, the thermoplastic polymer that is employed has, after production of the molding composition via compounding in the melt, a considerably higher relative viscosity than before the compounding. This is in turn disadvantageous for the further processing of the molding composition (e.g. in injection molding processes).

### BRIEF SUMMARY OF THE INVENTION

A thermoplastic glass fibers reinforced molding composition that exhibits improved mechanical properties and resistance to hydrolysis is disclosed. The composition contains at least one thermoplastic polymer, sized glass fibers, and optional conventional additives and auxiliary substances. The sizing agent that is substantially free of emulsifiers not bound to the resin contains (a) at least one epoxide-functional, oligomeric resin, having epoxide group content of 0.15 to 0.75 mole per 100 g of resin, average functionality of at least 2.3 epoxide groups per molecule, (b) at least one epoxide curing agents, and (c) at least one silane coupling agent.

### DETAILED DESCRIPTION OF THE INVENTION

The molding composition of the present invention could surprisingly be achieved by the use of special glass fiber sizing agents that contain an epoxide-functional, oligomeric resin as described for example in EP-A 0 612 798, in combination with an epoxide curing agent. The aforementioned undesired increase in viscosity of the thermoplastic polymer during the production of the molding composition may in this way be largely avoided. Surprisingly, it has also been found that the molding compositions according to the present invention have an improved hydrolytic resistance compared to molding compositions with sized glass fibers whose sizing agent contains an epoxide resin, but no epoxide curing agent.

This is all the more surprising since it would have been expected that, due to the addition of the epoxide curing agent, the mechanical properties of molding compositions reinforced with corresponding sized glass fibers would be impaired. Since epoxide curing agents react with the epoxide groups of the epoxide resin in the sizing agent and thereby reduce the epoxide group content of the sizing agent, the composite of glass fibers and polymer matrix should be adversely affected. The opposite is however the case.

The present invention provides molding compositions of thermoplastic polymers and glass fibers that have outstanding mechanical properties and good long-term properties, in particular resistance to hydrolysis, specifically under the stringent conditions of storage in hot water and the hot water/glycol test, and in which the relative viscosity of the thermoplastic polymer that is used does not increase or only slightly so during its production and further processing (for example injection molding processing).

The present invention provides molding compositions that contain

A) 100 parts by weight of thermoplastic polymers,

B) 5 to 250 parts by weight of sized glass fibers, and

C) 0 to 30 parts by weight of further conventional additives and auxiliary substances,

characterized in that the glass fibers (B) contain a sizing agent of the following composition:

a) one or more epoxide-functional, oligomeric resins that
(i) have a content of epoxide groups of 0.15 to 0.75 mole per 100 g of epoxide-functional, oligomeric resin, and
(ii) have on average a functionality of at least 2.3 epoxide groups per molecule, and also
(iii) are substantially free of emulsifiers not bound to the resin,

b) one or more water-dispersible or water-soluble epoxide curing agents, preferably selected from the group comprising amines, anhydrides, carboxylic acids, melamine/formaldehyde, mercaptans, phenols and polyisocyanates,

c) one or more silanes as coupling agent,

d) optionally further film-forming resins, auxiliary substances and additives.

Preferably the epoxide-functional, oligomeric resin contained in the sizing agent of the glass fibers is an epoxide group-containing polyester that may be obtained by the addition of 6 to 40 wt. % of an acid group-containing, polyoxy-alkylene-modified polyester with a content of oxyethylene units such that the proportion of oxyethylene units in the whole resin is at least 5%, and 60 to 94 wt. % of one or more epoxide group-containing compounds that

a) have a content of epoxide groups of 0.16 to 1.25 mole per 100 g of epoxide-functional, oligomeric resin, and

b) have on average a functionality of at least 2.3 epoxide groups per molecule.

Most particularly preferably the epoxide-functional, oligomeric resin contained in the sizing agent of the glass fibers is an epoxide group-containing polyester that may be obtained by the addition of 6 to 40 wt. % of an acid group-containing, polyoxyalkylene-modified polyester with a content of oxyethylene units such that 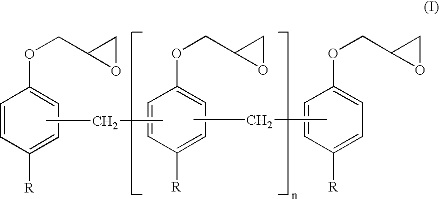
the proportion of oxyethylene units in the overall resin is at least 5%, and 60 to 94 wt. % of one or more epoxide group-containing compounds of the general formula (I)
wherein

R denotes hydrogen or an alkyl group with 1 to 5 carbon atoms, and

n is a number from 0.3 to 4.

Epoxide-functional, oligomeric resins are preferred having a mean molecular weight below 2000, particularly preferably below 1000.

The compounds on which the epoxide-functional resins are based are preferably aliphatic, cycloaliphatic, aromatic and heterocyclic compounds with epoxide groups that are known per se and are customarily used industrially. Such compounds on average contain two or more epoxide groups per molecule. There must however be used at least one compound having a functionality of more than two in such an amount that the epoxide-functional resin has on average a functionality of at least 2.3 epoxide groups per molecule.

The compounds on which the aforementioned epoxide-containing compounds are based preferably have up to 45 C atoms and constitute for example, but not limited to, epoxidizable diphenols or polyphenols, dicarboxylic or polycarboxylic acids, dicarboxylic or polycarboxylic acid anhydrides, dihydric or polybydric alcohols, or at least doubly unsaturated compounds.

Examples of compounds with more than two epoxide groups include, but are not limited to, the following: polyglycidyl ethers of polyhydric phenols, for example of Novolaks (transesterification products of monohydric or polyhydric phenols with aldehydes, in particular formaldehyde, in the presence of acid catalysts), tris-(4-hydroxyphenyl)methane or 1,1,2,2-tetra(4-hydroxyphenyl)ethane; epoxide compounds based on aromatic amines and epichlorohydrin, for example tetraglycidyl methylenedianiline, N-diepoxypropyl-4-aminophenylglycidyl ether; glycidyl esters of polybasic aromatic, aliphatic and cycloaliphatic carboxylic acids; glycidyl ethers of polyhydric alcohols, for example of glycerol, trimethylolpropane and pentaerythritol, and further glycidyl compounds such as trisglycidyl isocyanurate.

Preferred are polyglycidyl ethers of polyhydric phenols, and particularly preferred are polyglycidyl ethers of Novolaks.

Compounds containing two epoxide groups may however also be conjointly used. Such compounds are conjointly used in such an amount that the mixture of compounds containing two epoxide groups and compounds containing more than two epoxide groups has on average a functionality of at least 2.3 and preferably 2.5 to 5.4 epoxide groups per molecule.

Compounds containing two epoxide groups are for example, but not limited to, diglycidyl ethers of dihydric phenols such as pyrocatechol, resorcinol, hydroquinone, 4,4′-dihydroxy-diphenyldimethylmethane, 4,4′-dihydroxy-3,3′-dimethyldiphenylpropane, 4,4′-dihydroxydiphenylsulfone, glycidyl esters of dibasic aromatic, aliphatic and cycloaliphatic carboxylic acids such as for example phthalic acid hydride bisglycidyl ether or adipic acid bisglycidyl ether or glycidyl ethers of dihydric aliphatic alcohols such as butanediol bisglycidyl ether, hexanediol bisglycidyl ether or polyoxyalkylene glycol bisglycidyl ethers.

The epoxide-functional oligomeric resins may be modified to a small extent, i.e. by reacting at most 40% of all epoxide groups, preferably at most 15% of all epoxide groups, preferably in order to convert the resin into a form dispersible in water. The modified, epoxide-functional, oligomeric resins have after modification a content of epoxide groups of 0.15 to 0.75 mole per 100 g of epoxide-functional, oligomeric resin and on average a functionality of at least 2.3 epoxide groups per molecule, and are substantially free of emulsifiers not bound to the resin.

The acid group-containing, polyoxyalkylene-modified polyesters are obtained by esterification of polyoxyethylene-containing, polyoxypropylene-containing or possibly higher polyoxyalkylene-containing polyhydric- alcohols and dicarboxylic acids or their esterification derivatives as well as optionally monocarboxylic acid in a manner known per se (see for example Houben-Weyl, Methoden der Organischen Chemie, Stuttgart, 1963, Vol. 14/2, pp. 1-5, 21-23, 40-44; C. Martens Alkyd-Resins, Reinold Publ. Comp. 1961, Reinhold Plastics appl. Ser., 51-59) up to acid numbers of 5 to 200, preferably 30 to 100 mg KOH/g. It is also possible to use monocarboxylic acids and monohydric alcohols. These polyesters are then reacted with compounds containing one or more epoxide groups that have a content of epoxide groups of 0.16 to 1.25 mole per 100 g of epoxide-functional, oligomeric resin and on average a functionality of at least 2.3 epoxide groups per molecule, at temperatures between 20° and 200° C., preferably between 80° and 150° C. The esterification and the epoxy addition may be carried out in one or more stages. In a special embodiment the acid group-containing, polyoxy-alkylene-modified polyesters are reacted with compounds containing one or more epoxide groups so that, after the reaction, a residual acid number of 0.5 to 20, preferably 4 to 10 mg KOH/g, still remains.

The epoxide group-containing resin is described in more detail and characterized in EP-A 612 798.

The epoxide-functional, oligomeric resin is contained in the sizing agent of the glass fibers in an amount of 40 to 95 wt. %, particularly preferably between 40 and 85 wt. %, referred to the solids of the sizing agent (components a) to d)). Further film-forming resins, for example, but not limited to, those based on polyurethane, polyvinyl acetate, higher molecular weight epoxide resins or polyesters, may also be added to the sizing agents according to the present invention. The proportion of the sizing agent is preferably 2 to 0.1 wt. %, particularly preferably 1.3 to 0.3 wt. %, referred to the sized glass fibers.

The epoxide curing agent b) comprises compounds containing aromatic and aliphatic, monofunctional and/or polyfunctional amines, polyamines, anhydrides, carboxylic acids, melamine/forrnaldehyde, mercaptans, phenols and polyisocyanates, such as are described for example in Organic Coatings, Science and Technology, 2^{nd} Edition, 1999, Wiley, New York, ISBN 0-471-24507-0, pp. 214-225. They are preferably present in an amount such that the molar ratio of reactive groups of the component b) to the epoxide groups of component a) is 1:100 to 35:100, preferably 1:100 to 25:100, particularly preferably 1:100 to 20:100.

Preferably the epoxide curing agent contained in the glass fiber sizing agent are compounds that are dispersible or soluble in water.

Particularly preferably the epoxide curing agent contained in the glass fiber sizing agent are aliphatic or aromatic amines with secondary and/or primary amino groups, in which connection combinations of various amines may also be used.

Particularly preferably the epoxide curing agent contained in the glass fiber sizing agent are aliphatic diamines with primary amino groups, in which connection combinations of various diamines may also be used.

Most particularly preferably the epoxide curing agent contained in the glass fiber sizing agent is hexamethylenediamine.

The sized glass fibers are produced by known methods and further components such as, but not limited to, emulsifiers, further film-forming resins, coupling agents, lubricants and auxiliary substances such as wetting agents or antistatics may be contained in the sizing agent. The coupling agents, lubricants and auxiliary substances, the process for the production, the process for the coating and the post-treatment of the glass fibers are known per se and are described for example in K. L. Löwenstein, “The Manufacturing Technology of Continuous Glass Fibers”, Elsevier Scientific Publishing Corp., Amsterdam, London, New York, 1973. The glass fibers may be sized using any appropriate methods, for example with the aid of suitable devices such as spray or roller applicators, the sizing agents being applied to the glass filaments drawn at high speed from spinnerets, immediately after their solidification, i.e. still before the cutting process. It is however also possible to moisten the fibers only with water before they are cut and to spray the sizing agent composition onto the cut, wet glass fibers. The further additives and auxiliary substances are present preferably in an amount of up to 10 wt. % referred to components a) to d). The further film-forming resins are preferably present in an amount of up to 55 wt. % referred to the components a) to d). The coupling agents c) are preferably present in amounts of 1 to 40 wt. % referred to the components a) to d).

The thermoplastic polymers (A) contained in the molding compositions cover a large number of thermoplastic polymers. The following for example, but not limited to, are suitable as thermoplastic polymers: polymers such as styrene/acrylonitrile copolymers, ABS, polymethyl methacrylate or polyoxymethylene, aromatic and/or aliphatic polyamides, polycondensates such as polycarbonate, polyethylene terephthalate, polybutylene terephthalate, liquid crystalline polyaryl esters, polyphenylene oxide, polysulfone, polyarylene sulfide, polyaryl sulfone, polyether sulfone, polyaryl ether or polyether ketone or polyadducts such as polyurethanes or their mixtures.

As thermoplastic polymer (A) there are preferably used polyesters such as, but not limited to, polyethylene terephthalate and polybutylene terephthalate, polyarylene sulfides such as polyphenylene sulfide, and polyamides. Particularly preferred is the use of polyamides. Polyamides may be produced by various processes and synthesized from widely differing building blocks. They may preferably be used without or in combination with processing auxiliaries, stabilizers, polymeric alloying partners (e.g. elastomers) or also further reinforcing materials (such as for example mineral fillers).

Various process variants are known for the production of polyamides, wherein depending on the desired end product different monomer building blocks, various chain regulators for adjusting a desired molecular weight or also monomers with reactive groups for subsequently intended post-treatments may be employed.

The industrially relevant processes for the production of polyamides generally involve polycondensation in the melt. The hydrolytic polymerization of lactams is also understood as polycondensation in this context.

Preferred polyamides are partially crystalline polyamides that can be produced starting from diamines and dicarboxylic acids and/or lactams with at least 5 ring members or corresponding amino acids.

Suitable starting products are aliphatic and/or aromatic dicarboxylic acids such as adipic acid, 2,2,4- and 2,4,4-trimethyladipic acid, azelaic acid, sebacic acid, isophthalic acid, terephthalic acid, aliphatic and/or aromatic diamines such as for example tetramethylenediamine, hexamethylenediamine, 1,9-nonanediamine, 2,2,4- and 2,4,4-trimethylhexamethylenediamine, the isomeric diaminodicyclohexylmethanes, diaminodicyclohexylpropanes, bis-aminomethylcyclohexane, phenylenediamines, xylylenediamines, aminocarboxylic acids such as for example aminocaproic acid, or the corresponding lactams. Copolyamides of several of the aforementioned monomers may also be used.

Particularly preferably caprolactams such as ε-caprolactam are used as starting products.

Most particularly preferably adipic acid and hexamethylenediamine are used as starting products.

Compounds based on PA6, PA66 and other aliphatic and/or aromatic polyamides or copolyamides, in which 3 to 11 methylene groups are present on a polyamide group in the polymer chain, are furthermore particularly suitable.

The polyamides may also be used mixed with other polyamides and/or further polymers.

Conventional additives such as for example mold release agents, stabilizers and/or flow auxiliaries may be mixed with the polyamides in the melt or applied to the surface.

The molding compositions according to the present invention comprising thermoplastic polymers, glass fibers and conventional additives and auxiliary substances may be produced by any appropriate methods, for example by mixing the sized glass fibers in the form of chopped glass (chopped strands), rovings or short glass strands in extruders together with the molten thermoplastic materials, compressing them into strands and then processing them into plastics granules. These plastics granules serve as starting material for the production of molded parts and objects of glass fiber-reinforced thermoplastic material. Conventional additives and auxiliary substances, for example further fillers, stabilizers, pigments or colourants, may be added to the molding compositions. Such substances may for example include calcium carbonate, talcum, silica gel, barium sulfate, calcium sulfate, kaolin, bentonite, iron oxides, titanium dioxide, zeolites, wollastonite, dolomite, zinc oxide, magnesium carbonate, molybdenum disulfide, ground glass, glass spheres, quartz flour or mixtures thereof. Further fibrous fillers are for example, but not limited to, aramide fibers, carbon fibers, metal fibers or ceramic fibers. Further additives include for example, but not limited to, mold release agents, lubricants, anti-ageing agents, nucleating agents or flame retardants.

In addition further polymers may be added as blend partners. Examples of such polymers include, but are not limited to, polyethylene, polypropylene, polystyrene, polyvinyl chloride, polyphenylene sulfide sulfone, polyphenylene sulfide ketone, polyimides, polyamideimides, silicone resins, fluorine resins or mixtures, or copolymers or graft polymers of these polymers.

The molding compositions according to the present invention may be processed in a conventional way into molded parts, pressed parts and injection molded parts, thermoformed parts, semi-finished articles, boards such as, but not limited to, printed circuit boards, holders, instrument and vehicle parts, housings, rollers, gears, machine parts, fibers, films, profiled sections, headlamp reflectors and rolls. The molding compositions according to the present invention may in general advantageously be used where thermoplastic compositions are employed.

The present invention will be described in more detail with the aid of the following examples.

### EXAMPLES

### Example 1

### Production of Wet Chopped Glass Fibers

Deionized water is applied via a kiss-roll applicator to glass fibers of 11 μm diameter. The glass fibers are chopped into 4.5 mm-long chops (chopped strands) and packed wet. The water content of the wet chopped strands is 10 to 20 wt. %.

### Example 2

### Comparison

Water (20.0 g), a water-dispersed epoxide resin according to Example 1a of EP-A 612 798 with a solids content of 39 wt. % (24.4 g) and aminopropyltriethoxysilane (2.36 g) are added to a polyethylene flask and stirred while cooling at 0° C. After 1 hour water is added (130 g) and the pH of the composition is adjusted to 7 with acetic acid. The silane A 1387* (1.2 g), a water-dispersed epoxide resin according to Example 1a of EP-A 612 798 (24.4 g) and -aminopropyltriethoxysilane (2.36 g) are added and the pH of the composition is readjusted to 7 with acetic acid. A stable sizing agent dispersion with a solids content of 11 wt. % is formed. The sizing agent dispersion (45.6 g) is then sprayed, with constant stirring, onto the chopped wet glass fibers (water content 17 wt. %) from Example 1 (603 g), stirred for a further 5 minutes, and the glass fibers are then dried for 6 hours at 130° C. Sized glass fibers with a sizing agent content of about 1 wt. % are obtained.
*Polyazamide silane (50% in methanol), commercial product from Crompton.

### Example 3

The sizing agent dispersion from Example 2 (60 g) and 1,6-diaminohexane (0.055 g, corresponding to a molar ratio of amine groups to epoxide groups of 4:100) are added to a polyethylene flask and stirred at room temperature. After 30 minutes the pH of the composition is adjusted to 7 with acetic acid. A stable dispersion is obtained with a solids content of 10.6 wt. %.

The dispersion (56.39 g) is then sprayed, with constant stirring, onto the chopped wet glass fibers (water content 19 wt. %) from Example 1 (738 g), stirred for a further 5 minutes, and the glass fibers are dried for 6 hours at 130° C. Sized glass fibers with a sizing agent content of about 1 wt. % are obtained.

### Example 4

The sizing agent dispersion from Example 2 (60 g) and 1,6-diaminohexane (0.165 g, corresponding to a molar ratio of amine groups to epoxide groups of 12:100) are added to a polyethylene flask and stirred at room temperature. After 30 minutes the pH of the composition is adjusted to 7 with acetic acid. A stable dispersion with a solids content of 10.8 wt. % is obtained.

The dispersion (55.8 g) is then sprayed, with constant stirring, onto the chopped wet glass fibers (water content 19 wt. %) from Example 1 (738 g), stirred for a further 5 minutes, and the glass fibers are dried for 6 hours at 130° C. Sized glass fibers with a sizing agent content of about 1 wt. % are obtained.

### Example 5

### Comparison

The sizing agent dispersion from Example 2 (50 g) and 1,6-diaminohexane (0.46 g, corresponding to a molar ratio of amine groups to epoxide groups of 40:100) are added to a polyethylene flask and stirred at room temperature. After 30 minutes the pH of the composition is adjusted to 7 with acetic acid. A stable dispersion with a solids content of 12.8 wt. % is obtained.

The dispersion (39.2 g) is then sprayed, with constant stirring, onto the chopped wet glass fibers (water content 17 wt. %) from Example 1 (603 g), stirred for a further 5 minutes, and the glass fibers are dried for 6 hours at 130° C. Sized glass fibers with a sizing agent content of about 1 wt. % are obtained.

### Example 6

### Production of Molding Compositions

Components employed

A) 67.7 wt. % of polyamide-6,6 with a relative solution viscosity of 3.0 in m-cresol

B) 30.0 wt. % of glass fibers according to one of Examples 2 to 5

C) 2.1 wt. % of a 10 wt. % master batch of carbon black as black pigment in polyamide-6 and 0.2 wt. % of montan ester wax (Licowax EFL, commercial product from Clariant) as mold release agent.

Polyamide A) and the component C) are mixed, and melted in a continuously operating double-shaft extruder. The glass fibers (component B) are metered into the melt through a second metering funnel. The cylinder temperatures are chosen so that composition temperatures of 280° to 330° C. are maintained. The extruded strand is fed into water, granulated and dried. The relative viscosity of the granular material is measured in m-cresol. Test specimens measuring 80×10×4 mm³ are produced from the molding compositions in an injection molding machine. The flexural modulus, bending strength and outer fiber strain are tested according to DIN 53 437, as well as and the impact strength at room temperature according to Izod (ISO 180/1U) are determined after storing the specimens for specified times in an ethylene glycol/water mixture (1:1) at 130° C. and a pressure of ca. 2 bar.

The results are shown in the following table.

| | Example 2 (Comparison) | | | Example 3 | | | Example 4 | | | Example 5 (Comparison) | | |
|---|---|---|---|---|---|---|---|---|---|---|---|---|
| | (Amine/Epoxide | | | (Amine/Epoxide | | | (Amine/Epoxide | | | (Amine/Epoxide | | |
| | Groups = 0) | | | Groups = 0.04) | | | Groups = 0.12) | | | Groups = 0.40) | | |
| Glycol/Water Storage [days] | After 7 | After 14 | After 21 | After 7 | After 14 | After 21 | After 7 | After 14 | After 21 | After 7 | After 14 | After 21 |
| Flex. strength [MPa] | 95 | 55 | n.m. | 103 | 99 | 84 | 103 | 98 | 83 | 76 | n.m. | 33 |
| Flex. modulus [MPa] | 2850 | 2940 | n.m. | 2785 | 3037 | 3032 | 2972 | 3134 | 3085 | 2950 | n.m. | 2770 |
| Outer fiber strain [%] | 6.3 | 2.6 | n.m. | 6.4 | 5.5 | 4.3 | 6.3 | 5.4 | 4.0 | 4.7 | n.m. | 1.7 |
| Impact strength [kJ/m²] | 50 | 42 | 26 | 53 | 46 | 37 | 52 | 43 | 37 | 31 | 24 | 18 |

| | | | | |
|---|---|---|---|---|
| Relative viscosity | 3.26 (+9%) | 3.19 (+6%) | 3.10 (+3%) | 3.03 (+1%) |

n.m. = not measured

Relative viscosity: 1 wt. % in m-cresol at 25° C.

In the molding compositions that contain the glass fibers according to the invention of Examples 3 and 4, the mechanical properties, in particular the flexural strength and impact strength, scarcely change after hydrolytic ageing compared to the molding compositions that contain the glass fibers of Example 2. The viscosity of the resin after compounding with the glass fibers of Examples 3 and 4 changes only slightly.

Although the molding compositions that contain the glass fibers of Example 5 exhibit only a slight increase in viscosity, the mechanical properties after hydrolytic ageing are however very poor.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A thermoplastic molding composition, comprising:
A) 100 parts by weight of at least one thermoplastic polymer,
B) 5 to 250 parts by weight of sized glass fibers, and
C) 0 to 30 parts by weight of conventional additives and auxiliary substances,
wherein the glass fibers include a sizing agent comprising a) one or more epoxide-functional, oligomeric resins, that
(i) have a content of epoxide groups of 0.15 to 0.75 mole per 100 g of epoxide-functional, oligomeric resin,
(ii) have on average a functionality of at least 2.3 epoxide groups per molecule, and
(iii) are substantially free of emulsifiers not bound to the resin,
b) one or more water-dispersible or water-soluble epoxide curing agents,
c) one or more silanes coupling agents,
d) optionally at least one film-forming resin, auxiliary substances and additives.

2. The molding composition according to claim 1, wherein component a) is present in an amount of 40 to 95% relative to the total weight of components a) to d).

3. The molding composition according to claim 1, wherein component b) is present in an amount calculated to render the molar ratio of the reactive groups of b) to the epoxide groups of a) as 1:100 to 35:100.

4. The molding composition according to claim 1, wherein component c) is present in an amount of 1 to 40% relative to the total weight of components a) to d).

5. The molding composition according to claim 1, wherein at least one epoxide curing agent is an amine.

6. The molding composition according to claim 5, wherein the amine is hexamethylenediamine.

7. A molded article comprising the composition of claim 1.
